(19) United States
(12) Patent Application Publication
(10) Pub. No.: US 2006/0051186 A1
(43) Pub. Date: Mar. 9, 2006

(54) Unit for transferring and spacing articles

(75) Inventors: Lorenzo Maldina, Bologna (IT); Giancarlo Tedeschi, Gallo Bolognese di Castel S. Pietro (IT); Antonio Orillo, Via della Bastia (IT)

Correspondence Address: WILLIAM J. SAPONE;COLEMAN SUDOL SAPONE P.C., 714 COLORADO AVENUE, BRIDGE PORT, CT, 06605, US

(73) Assignee: COLEMAN SUDOL SAPONE P.C., BRIDGEPORT CT. (CT)

(21) Appl. No.: 10/533,273

(22) PCT Filed: Oct. 28, 2003
(86) PCT No.: PCT/IB03/04772

§ 371 Date: Jul. 14, 2005

(30) Foreign Application Priority Data
Oct. 30, 2002 (IT) BO2002A 000679

(51) Int. Cl. B65G 65/00

(52) U.S. Cl. 414/268

(57) ABSTRACT

A unit (1) for transferring articles (1) from a machine (MI) for producing these articles to a packaging machine (MA), includes a plurality of means (4a) for receiving said articles (1a), said receiving means (4a) being situated between an outlet station (3) of said producing machine (MI) and an inlet station (6) of said packaging machine (MA); the receiving means (4a) are arranged at a variable distance from one another and move alternatively between a first working configuration (A), in which the receiving means (4a) are moved closer to each other, in order to be situated in the region of, and in registry with, said outlet station (3) of the producing machine (MI), so as to receive said articles (1a), and a second working configuration (B), in which the receiving means (4a) are moved far from each other, in order to be situated in the region of, and in registry with, said inlet station (6) of the packaging machine (MA), so as to transfer the articles (1a) to the inlet station (6).

### FIELD OF THE INVENTION

The present invention relates to a unit for transferring articles from a producing machine to a packaging machine.

In particular, the present invention is used during the manufacturing of articles employed in food production field and during the packaging of the articles into relative boxes and/or cases and/or cartons.

### BACKGROUND OF THE INVENTION

The following description will refer explicitly to the production and packaging of the above articles, without losing its general character.

There are manufacturing or in-bagging machines, which fabricate welded tubular wrappings or bags of the type known as flow-pack, containing granular substances therein.

More in detail, the in-bagging machines produce bags beginning from a continuous sheet, of e.g. heat-weldable paper, which is preliminarily cut, so as to define a plurality of strips, vertically parallel.

Afterwards, each of the strips is brought to a tubular configuration by suitable folding means and then welded longitudinally along the edges.

In step relation with the longitudinal welding, the bottom of each vertical strip is also welded and afterwards, a measured quantity of the predetermined granular or powder substance is filled into the flow-pack.

When the filling is completed, each strip is welded again at top and cut near the median line of the welded portion, so as to detach it from the continuous sheet and to define the bottom of a subsequent tubular structure.

The so obtained sealed tubular bags, usually arranged one beside another in longitudinal vertical configuration, are withdrawn at the outlet portion of the in-bagging machine by suitable withdrawing and transferring means (for example by conventional suction means known as “pick and place”), and later fed, arranged longitudinally horizontally, to corresponding hoppers of an outlet station of the bag filling machine.

After the bags have been placed in the hoppers, the bottom of the hoppers are opened, so that the tubular bags are released to fall into corresponding boxes of a box conveyor, which constitutes an inlet portion of a packaging machine, aimed at packaging groups of bags into cases.

In order to ensure best and efficient transferring of the sealed tubular bags from the bagging machine to the packaging machine, the distance between the axes of two consecutive hoppers, or step, must be substantially equal to the corresponding step of the box-compartments of the packaging machine conveyor.

In this way, a correct filling of the conveyor box-compartments with a predetermined number of tubular bags is ensured.

Therefore, according to the above described known method, when the size of the tubular bags is changed, that is when one wants to produce tubular bags of different transverse dimensions, the step between the above hoppers, i.e. the distance between the hoppers, must be changed, and consequently, the step or distance between different box-compartments of the packaging machine conveyor must be adjusted and changed.

As it is easily understood, such changes result in difficult and complicated adjustment work, which causes long downtimes.

### SUMMARY OF THE INVENTION

The object of the present invention is to overcome the drawbacks and solve the problems of the above described prior art.

According to the present invention, a unit is manufactured for transferring articles from a producing machine to a packaging machine, and is characterized in that it includes a plurality of means for receiving said articles, said receiving means being situated between an outlet station of said producing machine and an inlet station of said packaging machine; said receiving means being arranged at a variable distance from one another and moving alternatively between a first working configuration, in which the receiving means are moved closer to each other, in order to be situated in the region of, and in registry with, said outlet station of the producing machine, so as to receive said articles, and a second working configuration, in which the receiving means are moved far from each other, in order to be situated in the region of, and in registry with, said inlet station of the packaging machine, so as to transfer the articles to the inlet station.

### BRIEF DESCRIPTION OF THE DRAWINGS

The characteristic features of the invention will be pointed out in the following description of a preferred, but not only embodiment, with particular reference to the enclosed figures, in which:

FIG. 1 is a schematic front, partially sectional view of a preferred embodiment of the transferring unit proposed by the present invention, with some parts removed for sake of clarity;

FIGS. 2, 3, 4 and 5 are front views of the same unit of FIG. 1 in different and subsequent working positions.

### DESCRIPTION OF THE PREFERRED EMBODIMENTS

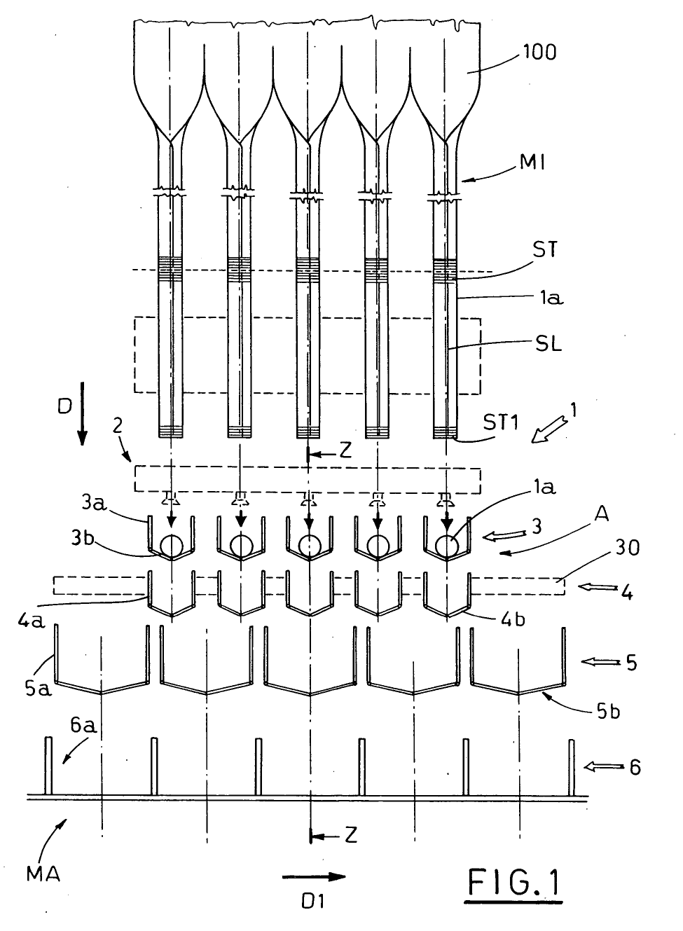

With reference to FIG. 1, the reference number 1 indicates a unit for transferring tubular bags 1a from a bagging machine MI to an inlet station 6, defined by a conveyor 6, of a packaging machine MA.

Each of the bags 1a contains preferably a granular or in-powder product (not shown). The bags are produced in a known way by the machine MI, beginning from a continuous sheet of a wrapping material 100. The wrapping material is cut or scored and closed with a longitudinal welding line SL and two crosswise welding lines ST and ST1 at the opposite ends of the so formed bag 1a. This kind of bag is known as the flow-pack.

According to FIG. 1, the bagging machine MI includes pickup means 2 which pick up, according to known technique, groups of tubular bags 1a arranged vertically, that is with the longitudinal welding lines SL arranged vertically parallel to a vertical direction D of the FIG. 1.

The pick up means drop the groups of tubular bags in horizontal configuration, that is with the longitudinal welding lines SL arranged horizontally and crosswise to the direction D, into a plurality of discharge buckets 3a of an outlet station s of the bag producing machine MI.

The discharge buckets 3a are preferably defined by hoppers 3a. The bottom ends 3b of the hoppers can be opened and are arranged at a fixed distance one from the other, as a function of the size of the tubular bags 1a, in particular of the transverse dimension of the bags 1a.

The unit 1, proposed by the present invention, includes a conveying line 4, situated downstream of the outlet station 3 of the bag making machine MI and equipped with a plurality of mobile buckets 4a. The distances between the axes of the mobile buckets, or step, can be varied.

A terminal line 5, situated in cascade with respect to the direction D, includes a plurality of terminal buckets 5a, arranged at fixed distances from one another and facing, each one, a relative box-compartment 6a of the inlet conveyor 6 of the packaging machine MA.

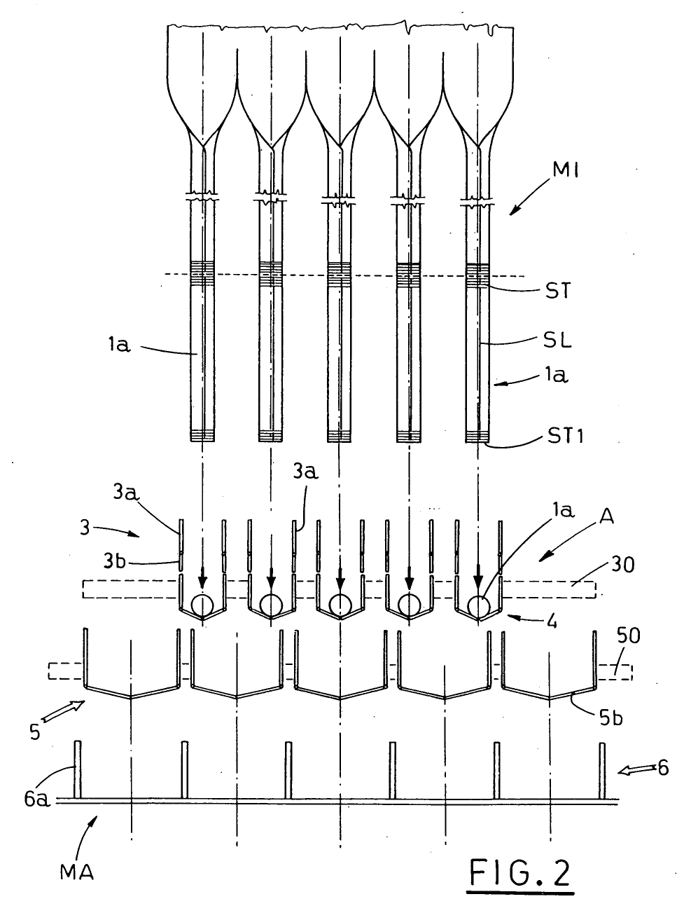

According to Figures from 1 to 5, the mobile buckets 4a are preferably defined by hoppers 4a; the bottom ends 4b of the mobile buckets can be opened. In operation, the distance between the axes of the mobile buckets 4a is changed from a receiving configuration A, in which the buckets 4a are situated each one below, and in registry with a relevant discharge hopper 3a, in order to receive the tubular bags 1a falling from the bottoms 3b (FIG. 2) being opened, to a release configuration B, in which each bucket 4a is situated above, and in registry with a relevant terminal bucket 5a, in order to drop the tubular bags 1a into the buckets 5a.

In order to allow the variable distance configuration of the hoppers 4a of the line 4, the hoppers 4a are slidably mounted on guides 30 (shown with broken line in Figures from 1 to 5), and are moved by motors, known and not shown, for example brush-less motors, so as to define and realize an alternate expansion/compression or pantographic movement.

More in detail, the mobile hoppers 4a are moved alternately far from and close to one another in relation to a plane Z substantially orthogonal to the working line 4 and to a movement direction Dl of the conveyor 6 (FIG. 1).

Still according to the enclosed figures, the buckets 5a of the terminal line 5 are likewise preferably defined by hoppers 5a having bottom ends 5b, which can be opened, and situated at a fixed distance from one another.

The distance can be suitably adjusted in relation to the size of the box compartments 6a of the conveyor 6, however independently from the size of the tubular bags 1a.

In particular, the distances between the axes of the hoppers 4a in the receiving configuration A are equal to the distances between the axes of the discharge hoppers 3a, situated above, and likewise, the distance between the axes of each pair of adjacent hoppers 4a in the release configuration B is preferably equal to the distance or step between the axes of the pairs of terminal hoppers 5a, situated below.

According to FIG. 2, in case the conveyor 6 of the machine MA is moved stepwise, the terminal hoppers 5a of the terminal line 5 can mounted on a support 50 (shown with broken line in FIG. 2), stationary with respect to the outlet station 3 of the bag making machine MI.

Otherwise, if the conveyor 6, equipped with box compartments 6a, moves continuously, the correct drop of the tubular bags 1a into the box compartments 6a is ensured by mounting the terminal hoppers 5a on a movable support 50, e.g. of the known follow-type, sliding with respect to the outlet station 3, in step relation with and at the same speed as the conveyor 6.

The operation of the unit 1 will be described in the following with reference to an operation step, in which the pickup means 2 have already dropped single bags 1a, in horizontal configuration, into each discharge hopper 3a.

In time relation with the drop of one tubular bag 1a into each discharge hopper 3a, the mobile hoppers 4a are moved to the receiving configuration A by compacting them slidingly along the guides 30, (FIG. 1). In this configuration, the bottoms 3b of the hoppers 3a open, so as to make the bags 1a fall directly into the hoppers 4a (FIG. 2).

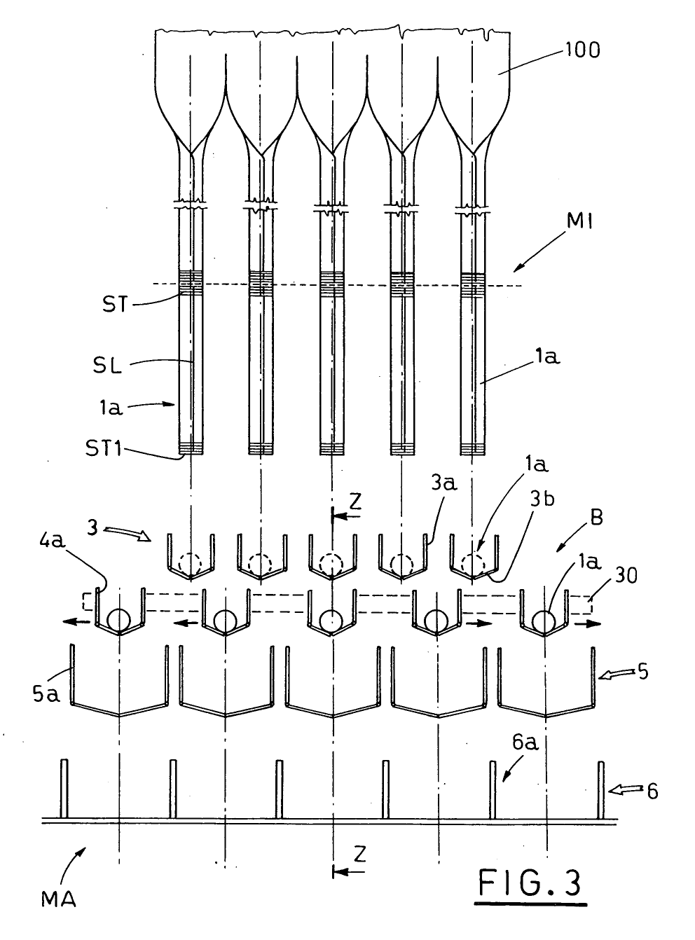

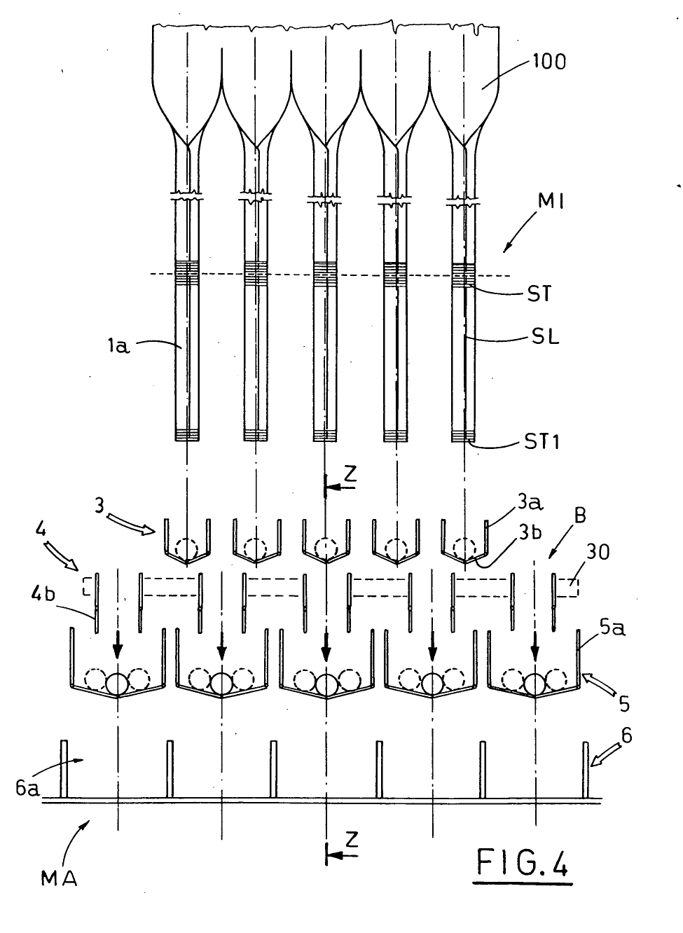

At this point, the hoppers 4a are moved in relative expansion along the guide 30 up to the release configuration B (FIG. 3), so as to be arranged exactly above the terminal hoppers 5a of the terminal line 5, and in such a way that, when the respective bottom ends 4b open, the bags 1a situated inside the hoppers 4a are free to fall into the respective terminal hoppers 5a (FIG. 4).

As it is better seen in FIG. 3, as soon as the tubular bags 1a are released from the outlet station 3 to the hoppers 4a, the discharge hoppers 3a are ready to receive subsequent bags 1a produced continuously by the bag machine MI.

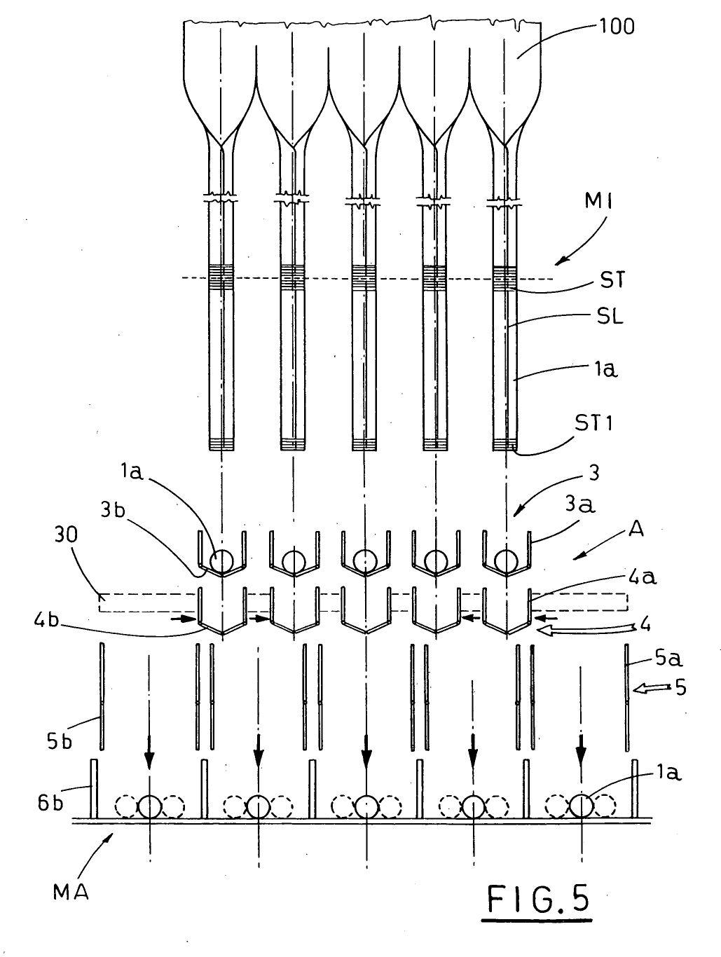

Likewise, as soon as the mobile hoppers 4a drop the tubular bags 1a, the same hoppers 4a are moved again, with a compression movement, to the receiving configuration A, waiting for tubular bags 1a, which will be released from the discharge hoppers 3a (FIG. 5), according to a continuous repetition of the production cycle.

When the bags 1a have reached the hoppers 5a, the bottoms 5b of the terminal hoppers 5a are opened, so that the bags fill the box-compartments 6a of the packaging machine MA conveyor 6.

In case the conveyor 6 is operated in a continuous motion, as soon as a predetermined number of tubular bags 1a are collected within each one of the terminal hoppers 5a, the moving support 50 is first driven so as to follow the box-compartments 6a, into which the hoppers 5a can release the bags 1a, and then it is made return with a backward motion up to a position corresponding to the release configuration B of the mobile hoppers 4a.

In the last case, the tubular bags 1a are released into to boxes 6a is obtained by keeping the terminal hoppers 5a in registry with the boxes 6a.

The so described unit 1 is used without substantial changes to transfer tubular bags 1a of different dimensions from the machine MI to the machine MA.

In fact, it is enough to adjust, by a simple operation, only the respective strokes which the mobile hoppers 4a run during the passage from the receiving configuration A, in which they are situated below the discharge hoppers 3a, to the release configuration B, in which they are situated above the terminal hoppers 5a.

Therefore, the proposed unit 1 allows quick and simple change-over operation, when the size of the articles being packaged is changed, thus reducing substantially the downtimes and therefore increasing the overall production rate.

In particular, according to the preferred embodiment, there are provided five mobile hoppers 4a, (that is an odd number of hoppers) and therefore, the central hopper 4a remains stationary, while the lateral hoppers are moved, so as to be set in registry either with the discharge hoppers 3a or with the terminal hoppers 5a, whichever is the case in accordance with the operation step.

The terminal hoppers 5a have suitable dimensions, which allow to release into the box-compartments 6a, underlying the terminal hoppers 5a, a number of tubular bags 1a, which varies within a wide range.

It is also to be pointed out that in this case, each group of hoppers 3a, 4a and 5a (discharge, mobile for transferring and terminal) when considered in vertical, feed a selected series of boxes 6a. Therefore, it is particularly easy to detect and correct possible wrong operation, for instance when an incorrect number of bags is contained in a box-compartment or the total weight of the bags contained in a box-compartment does not match the expected value. The verify can be easily performed by checking the cases packaged in the packaging machine MA and the correction can be effected directly upstream of the machine MA, acting on the vertical group of hoppers through which the bags are transferred from the machine MI to the machine MA.

Likewise, it is possible to perform a verify also in the case when faults and/or problems on a defined vertical group of hoppers are found, thus being possible to reject only packs containing the bags fed and transferred by this vertical group of hoppers.

According to alternative variants (not shown), it is possible to provide only one working line, e.g. conveying line 4, which can receive tubular bags 1a from the outlet station 3 of the bag making machine MI and can position them directly into the boxes of the conveyor 6 of the machine MA, without interposing the terminal line 5.

According to still another variant of the proposed transferring unit 1, the working line 4 receives articles directly from the withdrawing means 2 connected to the bag making machine MI, that is without interposing the discharge hoppers 3a.

1. A unit (1) for transferring articles (1) from a machine (MI) for producing these articles to a packaging machine (MA), the unit including:
a plurality of means (4a) for receiving said articles (1a), said receiving means (4a) being situated between an outlet station (3) of said producing machine (MI) and an inlet station (6) of said packaging machine (MA);
said receiving means (4a) being arranged at a variable distance from one another and moving alternatively between a first working configuration (A), in which the receiving means (4a) are moved closer to each other, in order to be situated in the region of, and in registry with, said outlet station (3) of the producing machine (MI), so as to receive said articles (1a), and a second working configuration (B), in which the receiving means (4a) are moved far from each other, in order to be situated in the region of, and in registry with, said inlet station (6) of the packaging machine (MA), so as to transfer the articles (1a) to the inlet station (6);
the unit being characterized in that said receiving means (4a) include a plurality of hoppers (4a) equipped with bottoms (4b), which can be opened; said hoppers (4a), being movable to said first working configuration (A), where they take positions corresponding and in registry with respective stationary hoppers (3a) placed at fixed mutual distances at said outlet station (3), and movable to said second working configuration (B), where they take positions corresponding and in registry with respective stationary hoppers (5a) placed at fixed mutual distances and belonging to an operative terminal line (5); said terminal line (5) being situated between said receiving means and said inlet station (6) and the relevant hoppers (5a) are so located to match corresponding box-compartments (6a) of a box-conveyor (6) of said inlet station.

2. A unit according to claim 1, characterized in that said receiving means (4a) are mounted moving on guide means (30), in order to alternatively compress/expand with respect to one another, under the action of motor means.

3. A unit according to claim 1 or 2, characterized in that said receiving means (4a) include a plurality of mobile hoppers (4a) with bottoms which can be opened, said mobile hoppers (4a) being capable of moving to said first working configuration (A), in which the mobile hoppers correspond and are in registry with corresponding hoppers (3a) of said outlet station (3), and moving to said second working configuration (B), in which the relevant bottoms (4b) of said mobile hoppers correspond to and are in registry with respective box-compartments (6a) of a box-conveyor (6) of said inlet station (6).

4. A unit according to claim 1, characterized in that said operative terminal line (5) is mounted on a mobile support (50) in order to be moved at the same speed as said box-conveyor (6) of said inlet station (6) of the packaging machine (MI)
